(19) United States
(12) Patent Application Publication
(10) Pub. No.: US 2011/0284552 A1
(43) Pub. Date: Nov. 24, 2011

(54) CRYNOGENIC STORAGE TANK

(75) Inventor: John G. Brothers, Washington Twp., MI (US)

(73) Assignee: Custom Biogenic Systems, Shelby Township, MI (US)

(21) Appl. No.: 13/110,229

(22) Filed: May 18, 2011

Related U.S. Application Data
(60) Provisional application No. 61/346,191, filed on May 19, 2010.

(51) Int. Cl. F17C 13/00

(52) U.S. Cl. 220/560.04

(57) ABSTRACT

A cryogenic storage tank having a housing which defines an interior chamber open at its top. A lid overlies the housing and storage chamber and an access opening is formed in the lid. An access door selectively closes the access opening while a carousel is rotatably mounted about an axis within the storage chamber. An actuator is accessible exteriorly of the lid and housing for rotating the carousel.

### CROSS REFERENCE TO RELATED APPLICATIONS

This application claims priority of U.S. Provisional Patent Application Ser. No. 61/346,191 filed May 19, 2010, which is incorporated herein by reference.

### BACKGROUND OF THE INVENTION

I. Field of the Invention

The present invention relates to cryogenic storage tanks for storing biological specimens.

II. Description of Related Art

In order to store biological specimens, such as blood, sperm, human eggs, tissue, and the like, it is necessary that the specimens be maintained at a very low temperature, e.g. −190° Fahrenheit. In order to achieve this, there have been previously known cryogenic storage tanks which typically use liquid nitrogen as a cooling agent for the specimens.

These previously known cryogenic storage tanks typically comprise a cylindrical tank of a one-piece construction. An access door, typically pie shaped, was formed on the top of the storage tank to provide access to the contents or specimens contained within the storage tank. Typically, these specimens are mounted within a carousel which is rotatably mounted within the interior of the cryogenic storage tank. Consequently, rotation of the carousel would bring different specimens into alignment with the access opening for removal of the specimens from the carousel or, conversely, insertion of new specimens into the carousel.

These previously known cryogenic storage tanks, however, all suffer from a number of common disadvantages. First, the wedge shaped access door on top of the storage tank made it difficult to access biological specimens contained near the middle of the tank since the access opening is very small near the middle of the tank. The same was also true for insertion of biological specimens into the carousel near its central or rotational axis.

A still further disadvantage of these previously known cryogenic storage tanks is that, to rotate the storage tank to bring different specimens into alignment with the access opening was typically performed manually by a technician inserting his or her hand into the interior of the storage tank and manually rotating the carousel. This, of course, required the technician to put a mitt or glove on the inserted hand in order to prevent injury to the technician caused by the cold temperatures within the storage tank. Indeed, even with mittens, the technician's hands are still exposed to extremely cold temperatures and the technician must hurry in order to properly align the carousel at the desired position. This sometimes results in technician errors.

Lastly, a further disadvantage of these previously known cryogenic storage tanks is that the tank and top were of a one-piece construction, typically joined by welds. Consequently, if a biological specimen were accidentally dropped into the interior of the tank outside of the carousel, in many cases it simply is not possible to gain access again to that biological specimen and that biological specimen, for all practical purposes, becomes lost. In many situations, however, that simply is not acceptable.

### SUMMARY OF THE PRESENT INVENTION

The present invention provides a cryogenic storage tank which overcomes the above-mentioned disadvantages of the previously known cryogenic storage tanks.

In brief, the cryogenic storage tank of the present invention comprises a housing which defines an interior storage chamber. The interior storage chamber is open at its top.

A lid overlies the housing and thus overlies the storage chamber. The lid is removably secured to the housing by threaded fasteners. Consequently, if required, the lid may be removed from the housing.

An access opening is formed in the lid to provide access to the contents of the storage chamber. Unlike the previously known cryogenic storage tanks, however, this access opening is generally rectangular in shape thus providing wider and more convenient access to the contents of the storage tank. An access door is removably positioned within the access opening to close the access opening when access to the interior of the storage chamber is not required.

A carousel is rotatably mounted within the storage chamber on an axle. One end of the axle is rotatably mounted to the bottom of the housing while the other end of the axle extends through the lid and upwardly from the exterior of the lid. This outwardly protruding upper portion of the axle forms an actuator surface to facilitate rotation of the carousel exteriorly of the housing and lid. Preferably, the actuator surface is hexagonal in shape so that the shaft and attached carousel may be rotated by a conventional wrench.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a preferred embodiment of the present invention and with the access door positioned in the access opening;

FIG. 2 is an exploded view of the preferred embodiment of the invention;

FIG. 3 is a view similar to FIG. 1, but illustrating the access door removed from the access opening;

FIG. 4 is a longitudinal sectional view with parts removed for clarity; and

FIG. 5 is a fragmentary top elevational view of the preferred embodiment of the present invention.

### DETAILED DESCRIPTION OF A PREFERRED EMBODIMENT OF THE PRESENT INVENTION

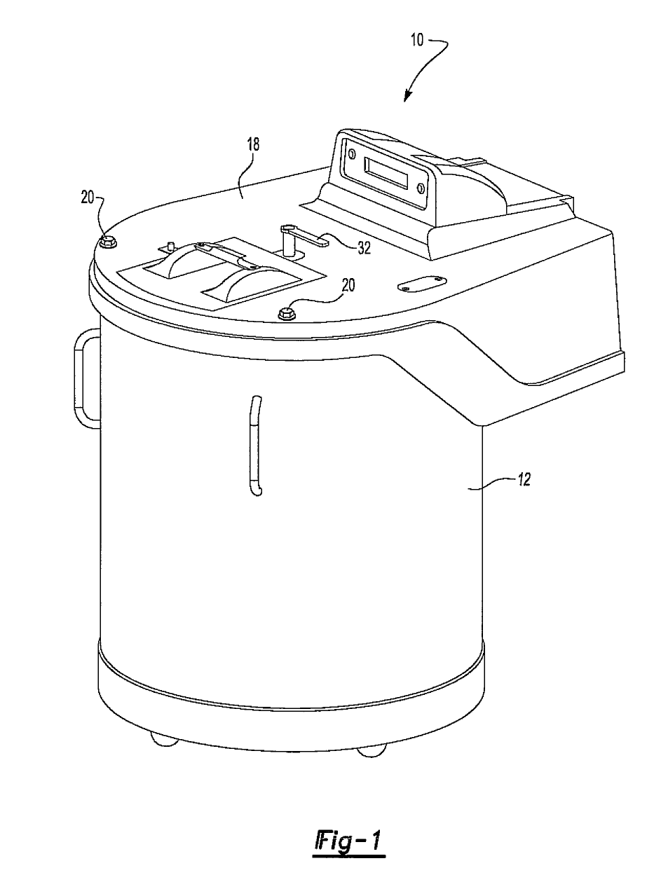

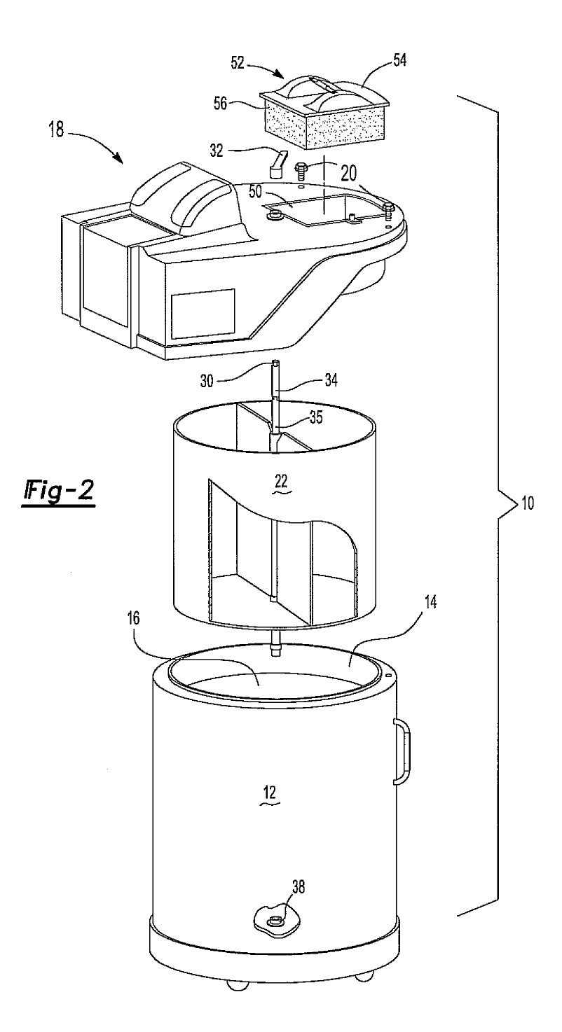

With reference first to FIGS. 1 and 2, a preferred cryogenic storage tank 10 in accordance with the present invention is illustrated. The tank 10 includes a generally cylindrical housing 12 having a closed bottom and an open top 14. The tank 12 thus defines an interior storage chamber 16 which is generally cylindrical in shape.

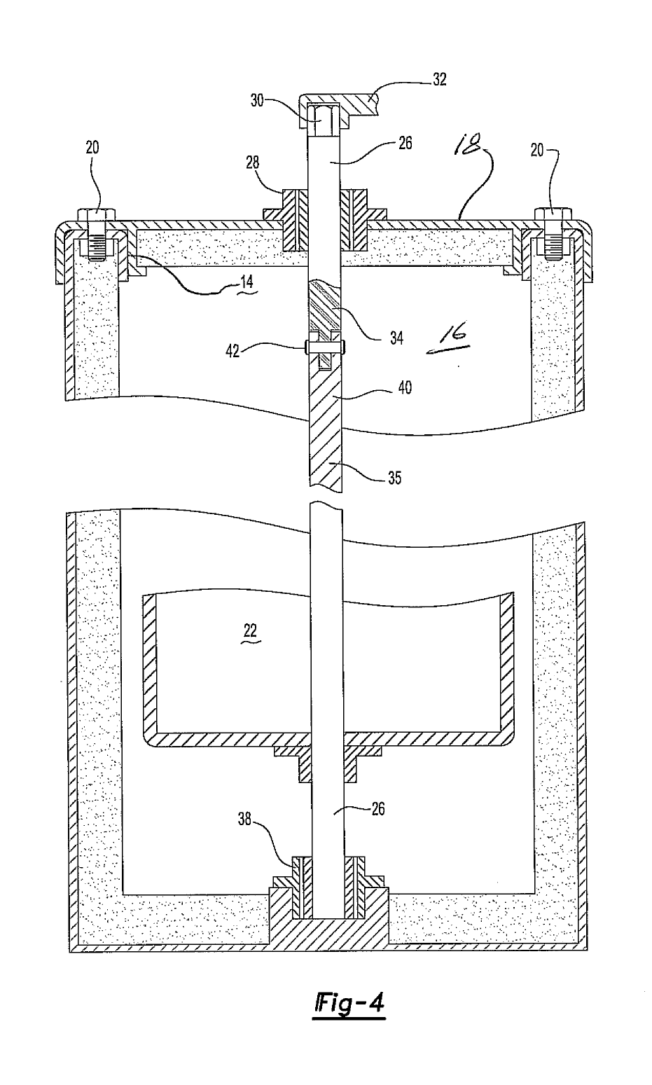

With reference now to FIGS. 1, 2 and 4, a lid 18 is positioned on top of the housing 12 so that the lid 18 overlies the open top 14 of the storage chamber 16. The lid 18, furthermore, is removably secured to the housing 12 by threaded fasteners 20 (FIG. 4). Consequently, if required, the lid may be easily removed from the tank 12 to provide access to specimens or other items that normally would not be accessible to a technician.

Referring now particularly to FIGS. 2 and 4, a cylindrical carousel 22 is rotatably mounted within the storage chamber 16 by an axle 24. A first or bottom end 26 of the axle is rotatably mounted to the bottom of the storage tank 12. Conversely, the opposite or upper end 26 of the axle 24 extends through and is rotatably mounted to the lid 18 by a bearing assembly 28.

As best shown in FIGS. 1 and 4, an actuator surface 30 (FIG. 4) is formed at the upper end of the axle 24. The actuator surface 30 is noncircular in shape, e.g. hexagonal in shape, so that a tool 32, such as a wrench, may engage the actuator surface 30 such that the tool 32 is used to rotate the carousel 22 to its desired rotational position.

With reference now to FIG. 4, the axle 24 includes a first axle segment 35 and a second axle segment 34. The first axle segment 35 is preferably made of metal, such as aluminum, and has its lower end 36 rotatably mounted to the bottom of the tank 12 by a bearing assembly 38. The first axle segment 35 has an upper end 40 which is positioned at an intermediate point along the axle 24 in between the lid 18 and the bottom of the housing 12.

The second axle segment 34 is axially aligned with the first axle segment 35 and is secured to the first axle segment 35 in any conventional fashion, such as by fasteners 42. It is the second axle segment 34, furthermore, that extends through and is rotatably mounted to the lid 18.

Unlike the first axle segment 35, the second axle segment 34 is constructed of a material, such as fiberglass, having low thermal conductivity. As such, the end 26 of the second axle segment 34 which protrudes upwardly and outwardly from the lid 18 remains substantially at room temperature, or slightly below room temperature. As such, very little heat energy is lost by thermal conduction along the shaft segment 34. In addition, a potential safety hazard from the upper end 26 of the shaft segment 34 is eliminated.

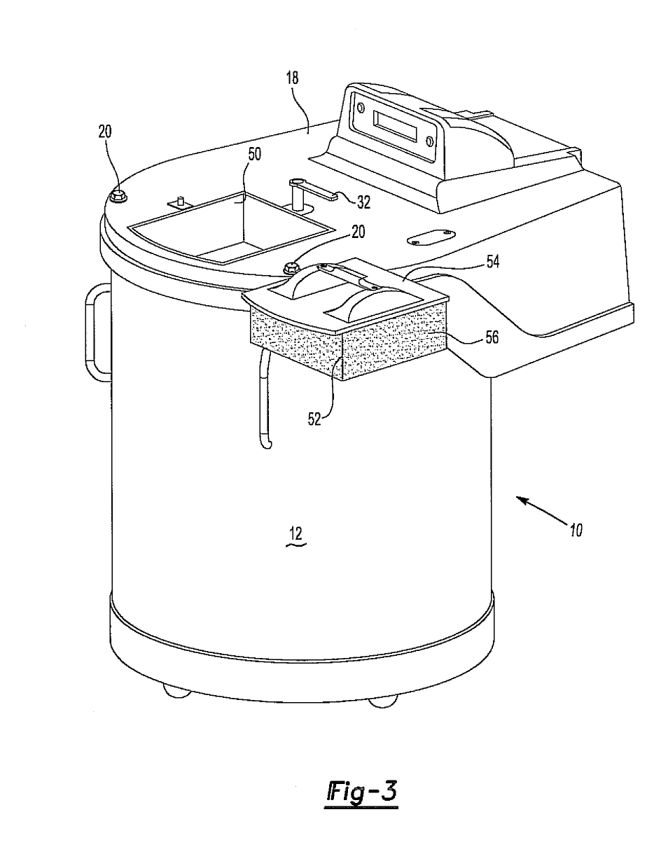

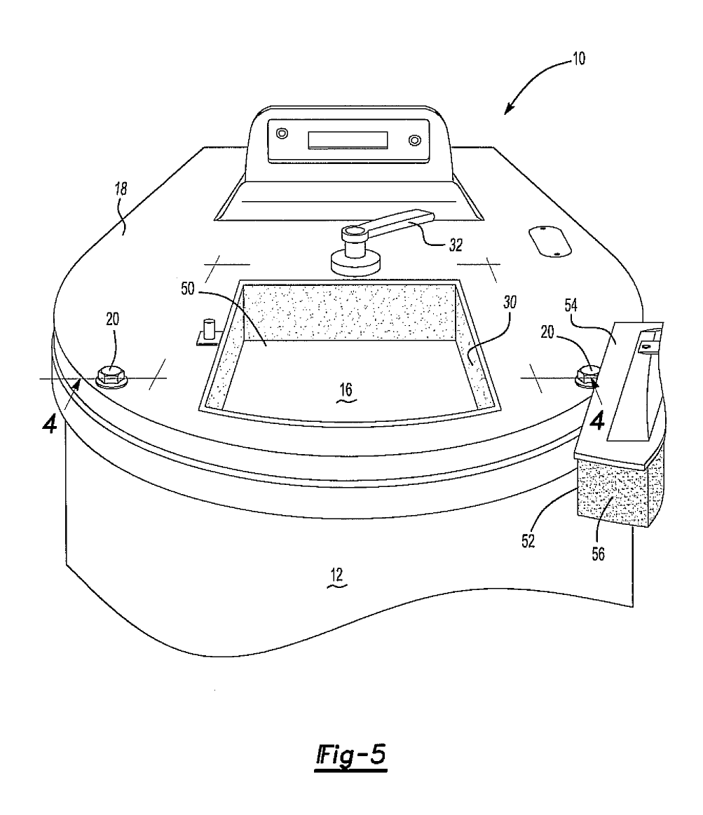

With reference now to FIGS. 3 and 5, an access opening 50 is formed through the lid 18 to enable specimens to be inserted into or removed from the carousel 22. Unlike the previously known cryogenic storage tanks, however, the access opening 50 is generally rectangular in shape to provide open access not only to the carousel near its outer periphery, but also similar access to the carousel at portions near its axis of rotation, i.e. the axis of the axle 24.

Referring now to FIGS. 1 and 3, an access door 52 which is complementary in shape to the access opening 50 is provided for selectively closing the access opening 50, as shown in FIG. 1, or opened to allow access to the carousel as shown in FIG. 3. An upper cover 54 on the door 52 is slightly larger than the access opening 50 so that the cover 54 rests upon the top of the lid 18 so that the access door 52 cannot fall into the interior of the storage tank 10. A thick layer of insulation 56 is attached to the cover 54 to thermally insulate the cover 54 from the interior temperatures of the cryogenic storage tank.

In operation, the carousel 22 may be easily rotated by the tool 32 until the desired portion of the carousel is aligned with the access opening 50. All this can be done, furthermore, exteriorly of the cryogenic storage chamber 16 so that insertion of a technician's hand into the interior of the storage chamber 16 is no longer required.

Furthermore, since the access opening is rectangular in shape, greater access to the interior of the storage tank and carousel 22 is achieved. However, even in the event of an accident where a specimen is dropped to the bottom of the storage tank, that specimen may be retrieved by removal of the lid 18 from the housing 12 after which full access to the interior of the storage chamber 16 is achieved upon removal of the carousel 22.

Having described my invention, many modifications thereto will become apparent to those skilled in the art to which it pertains without deviation from the spirit of the invention as defined by the scope of the appended claims.

I claim:

1. A cryogenic storage tank comprising:
a housing defining an interior storage chamber having an open top,
a lid which overlies said housing and said storage chamber, said lid having an access opening,
an access door which selectively closes said access opening,
a carousel rotatably mounted about an axis within said storage chamber, and
an actuator surface accessible exteriorly of said lid and said housing for rotating said carousel.

2. The cryogenic storage tank as defined in claim 1 and comprising an axle attached to said carousel, said axle having a first end rotatably mounted to said housing and a second end rotatably mounted to said lid.

3. The cryogenic storage tank as defined in claim 2 wherein said axle includes a first and a second axially aligned segments, said first segment extending from said first end of said axle to an intermediate position in said storage chamber and said second segment extending from said second end of said axle to said intermediate position in said storage chamber.

4. The cryogenic storage tank as defined in claim 3 wherein said second axle segment is constructed of a material having low thermal conductivity.

5. The cryogenic storage tank as defined in claim 4 wherein said second axle segment comprises a fiberglass material.

6. The cryogenic storage tank as defined in claim 2 wherein a portion of said axle extends upwardly from said lid, said actuator being attached to or formed on said upwardly extending portion of said axle.

7. The cryogenic storage tank as defined in claim 6 wherein said actuator comprises a noncircular portion of said upwardly extending portion of said axle.

8. The cryogenic storage tank as defined in claim 1 wherein said access opening is rectangular in shape.

9. The cryogenic storage tank as defined in claim 1 wherein said lid is removably attached to said housing.
